(19) United States
(12) Patent Application Publication
(10) Pub. No.: US 2020/0196394 A1
(43) Pub. Date: Jun. 18, 2020

(54) HEATABLE COVER DEVICE

(71) Applicant: Robert Bosch GmbH, Stuttgart (DE)

(72) Inventors: Annemarie Holleczek, Ludwigsburg (DE); Michael Zoeller, Beilstein (DE); Tobias Peterseim, Boeblingen (DE)

(21) Appl. No.: 16/715,552

(22) Filed: Dec. 16, 2019

(30) Foreign Application Priority Data
Dec. 17, 2018 (DE) 102018221876.5

(51) Int. Cl. H05B 3/18; C08L 69/00; C08L 33/12; H01Q 1/42

(52) U.S. Cl. CPC H05B 3/18; H01Q 1/422; C08L 33/12; C08L 69/005

(57) ABSTRACT

A cover device having a substrate made of plastic, and heating wires disposed within the substrate in a section of the substrate that is facing toward the outside when the cover device is used for its intended purpose.

RELATED APPLICATION INFORMATION

The present application claims priority to and the benefit of German patent application no. DE 10 2018 221 876.5, which was filed in Germany on Dec. 17, 2018, the disclosure of which is incorporated herein by reference.

### FIELD OF THE INVENTION

The present invention relates to a heatable cover device. In addition, the present invention relates to a method for producing a heatable cover device.

BACKGROUND INFORMATION

Heating devices for transparent surface elements are already known from the related art. For example, DE 10 2012 017 264 A1 discusses a windshield, which is provided with an anti-misting coating, for which a heating layer is provided in the inner region of the cover glass in one variant.

In addition, heating of a LIDAR cover glass (also known as a front cover) is discussed in DE 2011 122 345 A1, for instance. This document discusses a biaxial LIDAR scanner whose cover glass is partially heated. The transmission window remains unheated whereas the receiving window can be heated. In the provided heating concept, electrical circuit traces are applied, or deposited using a vapor deposition process, in the region of the receiving window.

Because of the broadly configured circuit traces, a high transmittance, especially in the region of the receiving window of the LIDAR cover glass, which is important for the range of the LIDAR, may be significantly reduced. In addition, the complete LiDAR cover glass has to be heated in the region of the receiving path, which requires a high electrical heat output. This type of cover glass and heating must be applied in the interior of the LIDAR cover glass, which is why the heat output has to be transmitted through the complete cover glass, which may increase the electrical energy consumption of the sensor to an enormous extent. Moreover, due to the through-heating, a higher temperature is expected at the inner side of the cover glass (the region of the vapor-deposited heater) in comparison to the outer side (the target region of the heating). As a result, the maximally achievable heating temperature at the outer side of the window depends on the temperature at the inner side of the heater, in particular in the case of a cover glass made of plastic. The effective surface temperature on the outer side is therefore reduced.

One solution, in which wooden wires are applied to the outer side, is not feasible as a solution for a heatable surface element because a cleaning or wiper system could abrade such circuit traces under certain conditions.

Known optoelectronic 3D scanners that are commercially available can be used only to a limited extent under difficult weather conditions such as rain, snowfall, fog, ice, etc., which greatly restricts their availability or usability. As a result, these 3D scanners are not suitable for automated driving at a level 5.

Different variants of optoelectronic 3D scanners are known. Among them are rotating macro scanners, MEMS-based scanners, OPA (optical phase array) LiDAR, and flash LIDAR. All mentioned systems have in common that they collect emitted laser light. Optical systems are available which are made up of a single lens or a plurality of lenses. All of them have a long optical receiving path and/or a large number of lenses.

This makes it possible to guide a beam having a diameter in the centimeter range across the rotating macro mirror in the transmission path. With the aid of such systems, in which all components are “rotating”, a horizontal field of view (FOV) of 360° is advantageously able to be scanned in a system-immanent manner.

### SUMMARY OF THE INVENTION

It is an object of the present invention to provide an improved cover device.

According to a first aspect, the present invention provides a cover device, which has
a substrate made of plastic; and
heating wires disposed within the substrate in a section of the substrate that faces towards the outside when the cover device is used for its intended purpose.

Because of the heating wires, which are disposed in the outer section of the substrate in a mounting position of the cover device according to the intended purpose, a heat output for the removal of moisture on the substrate may advantageously be very low. Since the substrate is made from plastic material, the heating wires are easily introduced into the substrate using time-tested methods, e.g., with the aid of an extrusion-coating method.

According to a second aspect, the objective is achieved by a method for producing a cover device, the method comprising the steps:
providing a substrate of plastic; and
providing heating wires within the substrate in a section of the substrate that faces toward the outside when the cover device is used for its intended purpose.

Specific embodiments of the cover device are the subject matter of the descriptions herein.

One advantageous further configuration of the cover device is characterized in that the heating wires are embedded in a heating foil. This results in an alternative provision of the heating wires in the outer section of the substrate.

An additional advantageous further configuration of the cover device is characterized in that the heating foil is made of the same material as the substrate. This realizes a stable material pairing since the heating foil and the substrate are made of the same material. Because of the required lamination process, the heating wires are situated very close to the surface of the substrate, which advantageously contributes to a high mechanical and thermal stability of the cover device.

According to another advantageous further configuration of the cover device, the substrate is polycarbonate or polymethylmethacrylate. This advantageously makes it possible to use a base material for the substrate that is easy to produce and cost-effective.

According to an additional advantageous further configuration of the cover device, a first hard material layer is applied at an end section of the substrate that faces toward the inside when the cover device is used for its intended purpose, and/or a second hard material layer is applied at the end section of the substrate that faces toward the outside. This allows for additional, optional layers, which particularly improve a scratch resistance of the cover device.

Another advantageous further configuration of the cover device is characterized in that a first anti-reflection layer is applied to the first hard material layer and/or that a second anti-reflection layer is applied to the second hard material layer. This makes it possible to provide better transmission characteristics for the cover device.

Another advantageous further configuration of the cover device is characterized in that the heating wires have a thickness of approximately 5 μm to approximately 40 μm, and particularly of approximately 10 μm to approximately 20 μm. Advantageous dimensions of the heating wires in relation to the dimensions of the substrate are achievable in this way.

Another advantageous further configuration of the cover device is characterized in that the heating wires are set apart from one another by approximately 1 mm to approximately 10 mm. This realizes advantageous clearances of the heating wires which facilitate an optimum heat output of the heating wires for the substrate.

Another advantageous further configuration of the cover device is characterized in that it additionally includes a detection device for detecting moisture, as well as a control unit for the electrical actuation of the heating wires, the control unit being functionally connected to the detection device. In an advantageous manner, this makes it possible to detect a moisture layer on the substrate, which causes a control unit to be activated, which actuates the heating wires for the demisting of the surface of the substrate or which optionally also actuates an additional cleaning device.

In the following text, the present invention will be described in detail together with further features and advantages on the basis of a plurality of figures. Identical or functionally equivalent components have been provided with identical reference numerals. The figures are particularly intended to illustrate the principles that are essential for the present invention and have not necessarily been drawn true to scale.

Disclosed device features similarly result from correspondingly disclosed method features, and vice versa. This particularly means that features, technical advantages and embodiments pertaining to the cover device similarly result from corresponding embodiments, features and advantages of the method for producing a cover device or from corresponding embodiments, features and advantages of the cover device, and vice versa.

### BRIEF DESCRIPTION OF THE DRAWINGS

FIG. 1 shows a basic illustration of a specific embodiment of a provided cover device.

FIG. 2 shows a basic illustration of a further specific embodiment of a provided cover device.

FIG. 3 shows a block diagram of a further specific embodiment of a provided cover device.

FIG. 4 shows a specific embodiment of a method for producing a cover device.

### DETAILED DESCRIPTION

A particular core aspect of the present invention is to provide an improved heatable cover device.

For the cover device, the use of heating elements made up of circuit traces in a substrate in the form of synthetic plastic, e.g., in the form of polycarbonate (PC) or polymethylmethacrylate (PMMA, “acrylic glass”, “plexiglass”), is provided. An advantageous application case for the provided cover device, i.e. as a cover glass of a LIDAR, is thereby able to be realized.

In an advantageous manner, this results in a low power consumption because the circuit traces are located close to the surface as a result of suitable production processes, or because a clearance of the heating elements (such as in the form of wires) with respect to the outer side of the cover glass is very small.

The circuit traces or wires have a diameter ranging from approximately 5 μm to approximately 40 μm and are situated at a distance of approximately 1 mm to approximately 10 mm. If used as a cover glass for a LIDAR system, this makes it possible to realize a greater transmittance, which results in a reduced loss of useful light so that a greater range of the sensor is advantageously able to be realized.

Higher surface temperatures of the outer surface (heated target surface) are possible in this way.

In addition, the provided cover device is able to be produced in a cost-effective manner with the aid of an injection molding or an injection-compacting method.

In an advantageous manner, it is optionally possible to coat the inner or outer surfaces in addition, e.g., with an anti- reflection coating and/or a hard material coating.

Optionally, an additional mechanical cleaning system is also realizable in the provided cover device.

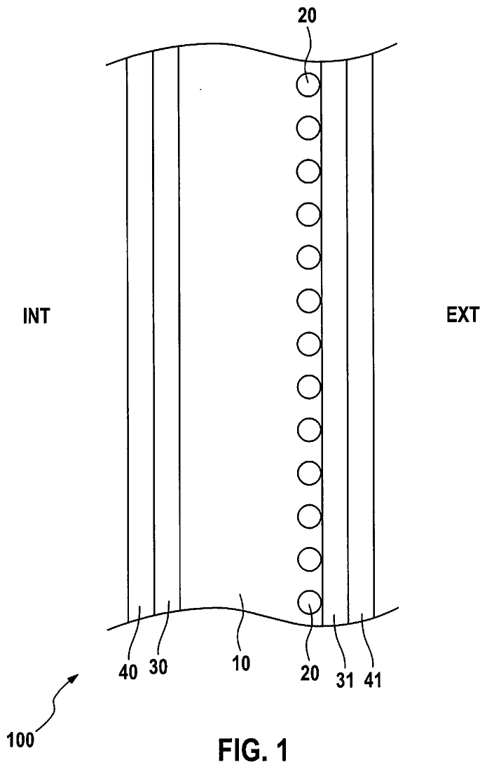

FIG. 1 shows a cross-section of a specific embodiment of provided cover device 100 which has a plurality of layers and/or components. A region denoted by INT can be seen, which is directed toward the inside in the direction of the LIDAR sensor (not shown). A substrate 10 or base material may be configured as a transparent plastic material such as polycarbonate or polymethylmethacrylate, which is permeable by electromagnetic radiation of the LIDAR sensor. Optionally, a first hard material layer 30 may be placed on substrate 10 on the inside and a first anti-reflection layer 40 is able to be placed thereon. In a similar manner, it is optionally possible to place a second hard material layer 31 on the outer side of substrate 10 as well and a second anti-reflection layer 41 on top thereof.

The mentioned additional layers 30, 40, 31, 41 increase the transmittance and the scratch resistance of the cover device for a corresponding wavelength of the LIDAR system.

On an outer side EXT, heating wires 20 have been introduced into substrate 10 by a suitable method (such as extrusion coating), heating wire 20 being extrusion-coated with the material of substrate 10 while freely suspended. In this way, heating wire 20 disposed within substrate 10 represents an electrically actuable resistance heater. It is activated in order to evaporate a moisture layer (not shown) on outer side EXT of cover device 100 with the aid of thermal energy, and to thereby keep cover device 100 for the LIDAR transparent on a permanent basis. This makes it possible to considerably improve the usability and/or efficiency of the LIDAR system.

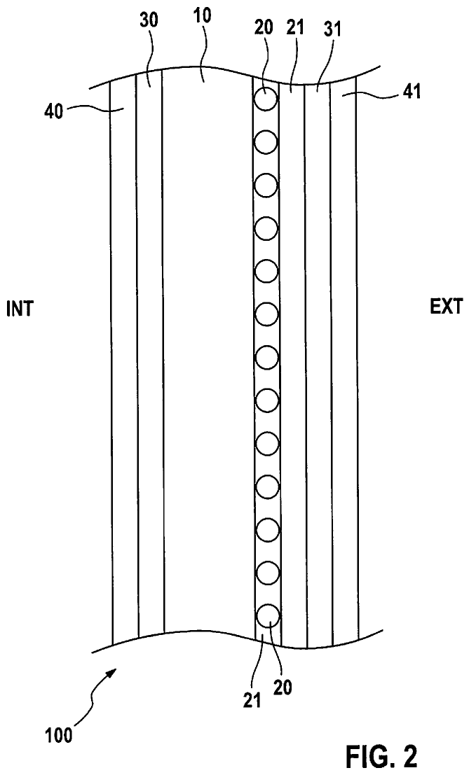

A second variant of a provided cover device is shown in FIG. 2. In this variant, it is provided that heating wire 20 is first applied to a heating foil 21 made of plastic (e.g., polycarbonate) in a meander-type pattern, for instance. Heating foil 21 then is able to be extrusion-coated or back-injection-molded and thus realizes heating wires 20 which are likewise situated on outer side EXT within substrate 10. Substrate 10 and heating foil 21 are advantageously made of the same material (such as polycarbonate) so that a compact material connection comes about as a result, and thus a high thermal and mechanical stability of entire cover device 100. Furthermore, the heating foil is able to be placed on substrate 10 and be connected to substrate 10 with the aid of a lamination process.

Heating wires 20 have a diameter which usually ranges in the micrometer range and may be set apart from one another in the millimeter range such as by approximately 1 mm to approximately 10 mm, the wire thickness and the placement of the wire paths of heating wires 20 being configured as a function of the required heat output.

In comparison with other approaches, e.g., radar heaters (mm range), substrate 10 features a high transmittance in the NIR (near-infrared range) and MIR (mid-infrared range) (approximately 800 nm-2000 m) because cover disk 100 has to be transparent for the emitted wavelength of the LIDAR sensor. In the case of camera systems, the transmission range may also lie in the VIS range (typically 400 nm to 800 nm) or in the MIR range (mid-infrared range), e.g., infrared cameras.

Heating wires 20 are therefore situated very close below the outer surface, as a result of which the outer side is able to be heated in an effective and energy-saving manner.

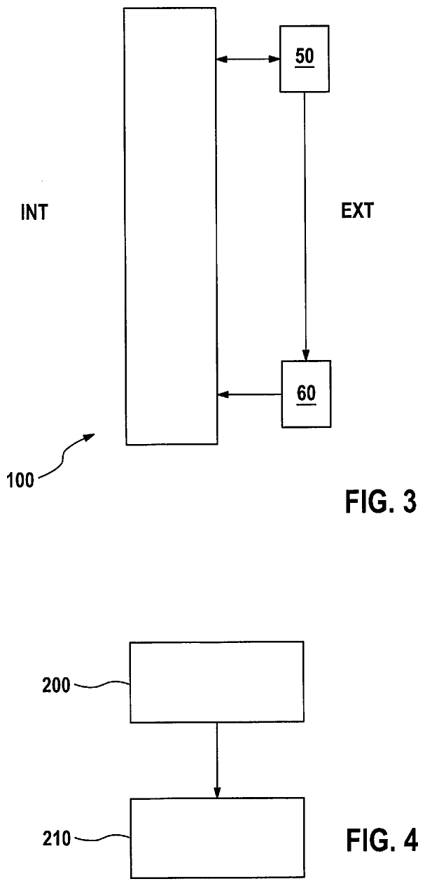

FIG. 3 shows a further specific embodiment of provided cover device 100 in the form of a block diagram. In this case, a detection device 50 is provided in addition, which is able to detect a film, e.g., in the form of moisture, ice, etc., on the outer side of substrate 10, detection device 50 being functionally connected to a control unit 60, which is provided for the electrical actuation of heating wires 20. In this way, heating wires 20 are activated only if detection device 50 has detected a film on substrate 10. Control unit 60, for example, may also be provided to actuate a mechanical cleaning device (not shown) by which substrate 10 is additionally able to be mechanically cleaned.

This supports an energy-saving operation of heating wires 20 inasmuch as they are activated only when a film is actually detected on substrate 10.

FIG. 4 shows a basic sequence of a specific embodiment of the provided method for producing a cover device 100.

In a step 200, a substrate 10 made of plastic is provided.

In a step 210, heating wires 20 are provided on a section of substrate 10 within substrate 10 that faces toward the outside when cover device 100 is used for its intended purpose.

Although the present invention has been described in connection with a heatable cover glass for an optoelectronic 3D scanner in the form of a LIDAR system, it is also conceivable, for example, to use the provided cover device in the automotive sector for a windshield, or, for instance, in the building sector, in the field of marine technology, aeronautics technology and others, e.g., for the purpose of demisting surfaces or removing condensate.

One skilled in the art thus understands that numerous variants are possible without departing from the core of the present invention.

What is claimed is:

1. A cover device, comprising:
a substrate made of plastic; and
heating wires disposed within the substrate in a section of the substrate that faces toward the outside when the cover device is used for its intended purpose.

2. The cover device of claim 1, wherein the heating wires are imbedded in a heating foil.

3. The cover device of claim 2, wherein the heating foil is made of the same material as the substrate.

4. The cover device of claim 1, wherein the substrate is polycarbonate or polymethylmethacrylate.

5. The cover device of claim 1, wherein a first hard material layer is applied at an end section of the substrate that faces toward the inside when the cover device is used for its intended purpose, and/or a second hard material layer is applied at the end section of the substrate that faces toward the outside.

6. The cover device of claim 4, wherein a first anti-reflection layer is applied on the first hard material layer and/or a second anti-reflection layer is applied on the second hard material layer.

7. The cover device of claim 1, wherein the heating wires have a thickness of approximately 5 μm to approximately 40 μm.

8. The cover device of claim 1, wherein the heating wires are set apart from one another by approximately 1 mm to approximately 10 mm.

9. The cover device of claim 1, further comprising:
a detection device to detect moisture; and
a control unit to electrically actuate the heating wires, wherein the control unit is functionally connected to the detection device.

10. A method for producing a cover device, the method comprising:
providing a substrate made of plastic; and
providing heating wires within the substrate in a section of the substrate that faces toward the outside when the cover device is used for its intended purpose.

11. The cover device of claim 1, wherein the cover device is used as a cover glass for an optoelectronic 3D scanner.

12. The cover device of claim 1, wherein the heating wires have a thickness of approximately 10 μm to approximately 20 μm.
